(19) United States
(12) Patent Application Publication
(10) Pub. No.: US 2021/0201372 A1
(43) Pub. Date: Jul. 1, 2021

(54) Cash Identification and Displacement Strategy

(71) Applicant: Visa International Service Association, San Francisco, CA (US)

(72) Inventors: Avinash Gupta, Dubai (AE); Ghanashyama Mahanty, Dubai (AE); Nadeem Uddin, Dubai (AE)

(21) Appl. No.: 16/492,234

(22) PCT Filed: Mar. 13, 2017
(86) PCT No.: PCT/US2017/022031

§ 371 Date: Sep. 9, 2019

(51) Int. Cl. G06Q 30/06; G06N 5/02; G06Q 20/38

(52) U.S. Cl. CPC G06Q 30/0601; G06Q 20/389; G06N 5/02

(57) ABSTRACT

A method, system, and apparatus for segmenting users based on transaction activity and propensity for conducting portable financial device transactions. The method includes: determining a subset of transaction data categories from a plurality of transaction data categories; ranking the subset of transaction data categories into at least one order; generating a predictive model for determining user propensity for prospectively increasing a frequency of portable financial device transactions based at least partially on the ranking of the at least one subset of transaction data categories; analyzing transaction data for portable financial device transactions initiated by each user of a plurality of users; generating at least one subset of users of the plurality of users; and automatically initiating a conversion action.

### BACKGROUND OF THE INVENTION

### Field of the Invention

This invention relates generally to displacing cash-based transactions with portable financial device transactions and, in some embodiments, to a method, system, and apparatus for segmenting users based on transaction activity and propensity for conducting portable financial device transactions.

### Description of Related Art

Conducting daily financial transactions using portable financial devices, such as payment by credit card, debit card, or an electronic wallet application, offers numerous advantages over other payment methods, such as using cash or personal check. These advantages include: ease of use at the point-of-sale, elimination of the need to carry large amounts of cash, and ability to earn rewards for use of the portable financial device. Such transactions are also beneficial for issuing institutions and transaction service providers for collecting transaction data that can be used for analysis. Despite these advantages, many people around the world still do not fully utilize, or utilize at all, portable financial devices for their financial transactions.

Portable financial device issuing institutions and transaction service providers of users who hold one or more portable financial devices are positioned to educate users about the benefits of their portable financial device and to incentivize those users to begin using, or to use more frequently, their portable financial device. However, given the large number of portable financial device holders for a given issuing institution or transaction service provider, it is prohibitively expensive and technologically infeasible to do so for every portable financial device holder.

Therefore, there is a need in the art for issuing institutions and transaction service providers to be able to determine users more likely to be receptive to their message and incentives regarding use or increased use of their portable financial devices so as to more efficiently reach those users.

### SUMMARY OF THE INVENTION

Accordingly, it is an object of the present invention to provide a method, system, and apparatus for automatically enrolling each user in at least one subset of users in at least one incentive program or automatically initiating a conversion action to convert at least one user in at least one subset of users to more frequent performance of portable financial device transactions.

According to a non-limiting embodiment, provided is a method of segmenting users based on transaction activity and propensity for conducting portable financial device transactions, including: determining at least one subset of transaction data categories from a plurality of transaction data categories; ranking the at least one subset of transaction data categories into at least one order; generating, with at least one processor, at least one predictive model for determining user propensity for prospectively increasing a frequency of portable financial device transactions based at least partially on the ranking of the at least one subset of transaction data categories; analyzing, with at least one processor, transaction data for portable financial device transactions initiated by each user of a plurality of users to identify at least one transaction for each user that corresponds to at least one transaction data category of the at least one subset of transaction data categories; generating, with at least one processor, at least one subset of users of the plurality of users based at least partially on the at least one predictive model and the at least one transaction identified for each of the plurality of users; and automatically enrolling, with at least one processor, each user in the at least one subset of users in at least one incentive program.

According to another non-limiting embodiment, provided is a method of segmenting users based on transaction activity and propensity for conducting portable financial device transactions, including: determining at least one subset of transaction data categories from a plurality of transaction data categories; ranking the at least one subset of transaction data categories into at least one order; generating, with at least one processor, at least one predictive model for determining user propensity for prospectively increasing a frequency of portable financial device transactions based at least partially on the ranking of the at least one subset of transaction data categories; analyzing, with at least one processor, transaction data for portable financial device transactions initiated by each user of a plurality of users to identify at least one transaction for each user that corresponds to at least one transaction data category of the at least one subset of transaction data categories; generating, with at least one processor, at least one subset of users of the plurality of users based at least partially on the at least one predictive model and the at least one transaction identified for each of the plurality of users; and automatically initiating, with at least one processor, a conversion action to convert at least one user in the at least one subset of users to more frequent performance of portable financial device transactions.

According to another non-limiting embodiment, provided is a method of segmenting users based on transaction activity and propensity for initiating portable financial device transactions, including: generating a plurality of transaction data categories corresponding to a propensity to increase portable financial device transaction frequency based at least partially on past transaction data; generating and assigning weights to each transaction data category of the plurality of transaction data categories based at least partially on the past transaction data; determining, with at least one processor, a plurality of users having at least one transaction that corresponds to at least one transaction data category of the plurality of transaction data categories; generating, with at least one processor, a score for each user of the plurality of users based at least partially on transaction data for that user and the weight assigned to the at least one transaction that corresponds to at least one transaction data category of the plurality of transaction data categories; generating, with at least one processor, at least one subset of users of the plurality of users based at least partially on the score for each user of the plurality of users; and automatically initiating, with at least one processor, a conversion action to convert at least one user in the at least one subset of users to more frequent performance of portable financial device transactions.

According to another non-limiting embodiment, provided is a computer program product for segmenting users based on transaction activity and propensity for conducting portable financial device transactions, including at least one non-transitory computer-readable medium including program instructions that, when executed by at least one processor, cause the at least one processor to: determine at least one subset of transaction data categories from a plurality of transaction data categories; rank the at least one subset of transaction data categories into at least one order; generate at least one predictive model for determining user propensity for prospectively increasing a frequency of portable financial device transactions based at least partially on the ranking of the at least one subset of transaction data categories; analyze transaction data for portable financial device transactions initiated by each user of a plurality of users to identify at least one transaction for each user that corresponds to at least one transaction data category of the at least one subset of transaction data categories; generate at least one subset of users of the plurality of users based at least partially on the at least one predictive model and the at least one transaction identified for each of the plurality of users; and automatically initiate a conversion action to convert at least one user in the at least one subset of users to more frequent performance of portable financial device transactions.

According to another non-limiting embodiment, provided is a system for segmenting users based on transaction activity and propensity for conducting portable financial device transactions, including: a database comprising user transaction data comprising: a plurality of transaction data categories and transaction data for portable financial device transactions initiated by each user of a plurality of users; and at least one processor in communication with the database, the at least one processor programmed or configured to: determine at least one subset of transaction data categories from the plurality of transaction data categories; rank the at least one subset of transaction data categories into at least one order; generate at least one predictive model for determining user propensity for prospectively increasing a frequency of portable financial device transactions based at least partially on the ranking of the at least one subset of transaction data categories; analyze the transaction data for portable financial device transactions initiated by each user of a plurality of users to identify at least one transaction for each user that corresponds to at least one transaction data category of the at least one subset of transaction data categories; generate at least one subset of users of the plurality of users based at least partially on the at least one predictive model and the at least one transaction identified for each of the plurality of users; and automatically initiate a conversion action to convert at least one user in the at least one subset of users to more frequent performance of portable financial device transactions.

Further embodiments or aspects are set forth in the following numbered clauses:

Clause 1: A method of segmenting users based on transaction activity and propensity for conducting portable financial device transactions, comprising: determining at least one subset of transaction data categories from a plurality of transaction data categories; ranking the at least one subset of transaction data categories into at least one order; generating, with at least one processor, at least one predictive model for determining user propensity for prospectively increasing a frequency of portable financial device transactions based at least partially on the ranking of the at least one subset of transaction data categories; analyzing, with at least one processor, transaction data for portable financial device transactions initiated by each user of a plurality of users to identify at least one transaction for each user that corresponds to at least one transaction data category of the at least one subset of transaction data categories; generating, with at least one processor, at least one subset of users of the plurality of users based at least partially on the at least one predictive model and the at least one transaction identified for each of the plurality of users; and automatically enrolling, with at least one processor, each user in the at least one subset of users in at least one incentive program.

Clause 2: The method of clause 1, wherein ranking the at least one subset of transaction data categories into the at least one order comprises assigning a weight value to each transaction data category of the at least one subset of transaction data categories.

Clause 3: The method of clause 1 or 2, wherein the at least one subset of transaction data categories comprises a first subset of transaction data categories and a second subset of transaction data categories, wherein the at least one predictive model comprises a first predictive model for users with less than a predefined number of transactions and is generated based at least partially on the first subset of transaction data categories and a second predictive model for users with at least a predefined number of transactions generated based at least partially on the second subset of transaction data categories.

Clause 4: The method of clause 3, wherein the first subset of transaction data categories comprises at least two of: amount of user cash withdrawals, average user international ticket size, user growth momentum of ticket size, days since last user transaction, user withdrawal consistency, and user card type.

Clause 5: The method of clause 3 or 4, wherein the second subset of transaction data categories comprises at least two of: number of user transactions, number of domestic user transactions, user growth momentum of monthly spending, days since last user transaction, number of market categories in which user is active, number of user supermarket transactions, amount of user spending at restaurants, and amount of user spending at gas stations.

Clause 6: The method of any of the preceding clauses, wherein the portable financial device transactions comprise a plurality of transactions initiated with a primary account number.

Clause 7: The method of any of the preceding clauses, wherein the at least one subset of users comprises users having a high propensity for prospectively increasing a frequency of portable financial device transactions based at least partially on the at least one predictive model.

Clause 8: A method of segmenting users based on transaction activity and propensity for conducting portable financial device transactions, comprising: determining at least one subset of transaction data categories from a plurality of transaction data categories; ranking the at least one subset of transaction data categories into at least one order; generating, with at least one processor, at least one predictive model for determining user propensity for prospectively increasing a frequency of portable financial device transactions based at least partially on the ranking of the at least one subset of transaction data categories; analyzing, with at least one processor, transaction data for portable financial device transactions initiated by each user of a plurality of users to identify at least one transaction for each user that corresponds to at least one transaction data category of the at least one subset of transaction data categories; generating, with at least one processor, at least one subset of users of the plurality of users based at least partially on the at least one predictive model and the at least one transaction identified for each of the plurality of users; and automatically initiating, with at least one processor, a conversion action to convert at least one user in the at least one subset of users to more frequent performance of portable financial device transactions.

Clause 9: The method of clause 8, wherein the conversion action comprises enrolling each user in the at least one subset of users in at least one incentive program.

Clause 10: The method of clause 8 or 9, wherein the conversion action comprises generating and/or transmitting a communication to each user in the at least one subset of users.

Clause 11: The method of clause 10, wherein the communication comprises at least one of the following: a web-based communication, an email communication, a text message, a telephone call, a push notification, an instant message, or any combination thereof.

Clause 12: The method of any of clauses 8-11, wherein ranking the at least one subset of transaction data categories into the at least one order comprises assigning a weight value to each transaction data category of the at least one subset of transaction data categories.

Clause 13: The method of any of clauses 8-12, wherein the at least one subset of transaction data categories comprises a first subset of transaction data categories and a second subset of transaction data categories, wherein the at least one predictive model comprises a first predictive model for users with less than a predefined number of transactions and is generated based at least partially on the first subset of transaction data categories and a second predictive model for users with at least a predefined number of transactions generated based at least partially on the second subset of transaction data categories.

Clause 14: The method of clause 13, wherein the first subset of transaction data categories comprises at least two of: amount of user cash withdrawals, average user international ticket size, user growth momentum of ticket size, days since last user transaction, user withdrawal consistency, and user card type.

Clause 15: The method of clause 13 or 14, wherein the second subset of transaction data categories comprises at least two of: number of user transactions, number of domestic user transactions, user growth momentum of monthly spending, days since last user transaction, number of market categories in which user is active, number of user supermarket transactions, amount of user spending at restaurants, and amount of user spending at gas stations.

Clause 16: The method of any of clauses 8-15, wherein the portable financial device transactions comprise a plurality of transactions initiated with a primary account number.

Clause 17: The method of any of clauses 8-16, wherein the at least one subset of users comprises users having a high propensity for prospectively increasing a frequency of portable financial device transactions based at least partially on the at least one predictive model.

Clause 18: A method of segmenting users based on transaction activity and propensity for initiating portable financial device transactions, comprising: generating a plurality of transaction data categories corresponding to a propensity to increase portable financial device transaction frequency based at least partially on past transaction data; generating and assigning weights to each transaction data category of the plurality of transaction data categories based at least partially on the past transaction data; determining, with at least one processor, a plurality of users having at least one transaction that corresponds to at least one transaction data category of the plurality of transaction data categories; generating, with at least one processor, a score for each user of the plurality of users based at least partially on transaction data for that user and at least one weight assigned to the at least one transaction that corresponds to at least one transaction data category of the plurality of transaction data categories; generating, with at least one processor, at least one subset of users of the plurality of users based at least partially on the score for each user of the plurality of users; and automatically initiating, with at least one processor, a conversion action to convert at least one user in the at least one subset of users to more frequent use of portable financial device transactions.

Clause 19: The method of clause 18, wherein the conversion action comprises enrolling each user in the at least one subset of users in at least one incentive program.

Clause 20: The method of clause 18 or 19, wherein the conversion action comprises generating and/or transmitting a communication to each user in the at least one subset of users.

Clause 21: A computer program product for segmenting users based on transaction activity and propensity for conducting portable financial device transactions, comprising at least one non-transitory computer-readable medium including program instructions that, when executed by at least one processor cause the at least one processor to: determine at least one subset of transaction data categories from a plurality of transaction data categories; rank the at least one subset of transaction data categories into at least one order; generate at least one predictive model for determining user propensity for prospectively increasing a frequency of portable financial device transactions based at least partially on the ranking of the at least one subset of transaction data categories; analyze transaction data for portable financial device transactions initiated by each user of a plurality of users to identify at least one transaction for each user that corresponds to at least one transaction data category of the at least one subset of transaction data categories; generate at least one subset of users of the plurality of users based at least partially on the at least one predictive model and the at least one transaction identified for each of the plurality of users; and automatically initiate a conversion action to convert at least one user in the at least one subset of users to more frequent performance of portable financial device transactions.

Clause 22: The computer program product of clause 21, comprising a first computer-readable medium and a second computer-readable medium, wherein the first computer-readable medium is maintained and/or hosted by a transaction service provider and the second computer-readable medium is located remote from the transaction service provider.

Clause 23: The computer program product of clause 22, wherein the conversion action comprises enrolling each user in the at least one subset of users in at least one incentive program or generating and/or transmitting a communication to each user in the at least one subset of users.

Clause 24: The computer program product of clause 23, wherein the communication comprises at least one of the following: a web-based communication, an email communication, a text message, a telephone call, a push notification, an instant message, or any combination thereof.

Clause 25: The computer program of any of clauses 21-24, wherein ranking the at least one subset of transaction data categories into the least one order comprises assigning a weight value to each transaction data category of the at least one subset of transaction data categories.

Clause 26: The computer program of any of clauses 21-25, wherein the at least one subset of transaction data categories comprises a first subset of transaction data categories and a second subset of transaction data categories, wherein the at least one predictive model comprises a first predictive model for users with less than a predefined number of transactions and is generated based at least partially on the first subset of transaction data categories and a second predictive model for users with at least a predefined number of transactions generated based at least partially on the second subset of transaction data categories.

Clause 27: The computer program product of clause 26, wherein the first subset of transaction data categories comprises at least two of: amount of user cash withdrawals, average user international ticket size, user growth momentum of ticket size, days since last user transaction, user withdrawal consistency, and user card type.

Clause 28: The computer program product of clause 26 or 27, wherein the second subset of transaction data categories comprises at least two of: number of user transactions, number of domestic user transactions, user growth momentum of monthly spending, days since last user transaction, number of market categories in which user is active, number of user supermarket transactions, amount of user spending at restaurants, and amount of user spending at gas stations.

Clause 29: The computer program product of any of clauses 21-28, wherein the portable financial device transactions comprise a plurality of transactions initiated with a primary account number.

Clause 30: The computer program product of any of clauses 21-29, wherein the at least one subset of users comprises users having a high propensity for prospectively increasing a frequency of portable financial device transactions based at least partially on the at least one predictive model.

Clause 31: A system for segmenting users based on transaction activity and propensity for conducting portable financial device transactions, comprising: at least one database comprising user transaction data, the user transaction data comprising: a plurality of transaction data categories and transaction data for portable financial device transactions initiated by each user of a plurality of users; and at least one processor in communication with the at least one database, the at least one processor programmed or configured to: determine at least one subset of transaction data categories from the plurality of transaction data categories; rank the at least one subset of transaction data categories into at least one order; generate at least one predictive model for determining user propensity for prospectively increasing a frequency of portable financial device transactions based at least partially on the ranking of the at least one subset of transaction data categories; analyze the transaction data for portable financial device transactions initiated by each user of a plurality of users to identify at least one transaction for each user that corresponds to at least one transaction data category of the at least one subset of transaction data categories; generate at least one subset of users of the plurality of users based at least partially on the at least one predictive model and the at least one transaction identified for each of the plurality of users; and automatically initiate a conversion action to convert at least one user in the at least one subset of users to more frequent performance of portable financial device transactions.

Clause 32: The system of clause 31 comprising a first processor and a second processor, wherein the first processor is located at a transaction service provider and the second processor is located remote from the transaction service provider.

Clause 33: The system of clause 31 or 32, wherein the conversion action comprises enrolling each user in the at least one subset of users in at least one incentive program or generating and/or transmitting a communication to each user in the at least one subset of users.

Clause 34: The system of clause 33, wherein the communication comprises at least one of the following: a web-based communication, an email communication, a text message, a telephone call, a push notification, an instant message, or any combination thereof.

Clause 35: The system of any of clauses 31-34, wherein ranking the at least one subset of transaction data categories into the least one order comprises assigning a weight value to each transaction data category of the at least one subset of transaction data categories.

Clause 36: The system of any of clauses 31-35, wherein the at least one subset of transaction data categories comprises a first subset of transaction data categories and a second subset of transaction data categories, wherein the at least one predictive model comprises a first predictive model for users with less than a predefined number of transactions and is generated based at least partially on the first subset of transaction data categories and a second predictive model for users with at least a predefined number of transactions generated based at least partially on the second subset of transaction data categories.

Clause 37: The system of clause 36, wherein the first subset of transaction data categories comprises at least two of: amount of user cash withdrawals, average user international ticket size, user growth momentum of ticket size, days since last user transaction, user withdrawal consistency, and user card type.

Clause 38: The system of clause 36 or 37, wherein the second subset of transaction data categories comprises at least two of: number of user transactions, number of domestic user transactions, user growth momentum of monthly spending, days since last user transaction, number of market categories in which user is active, number of user supermarket transactions, amount of user spending at restaurants, and amount of user spending at gas stations.

Clause 39: The system of any of clauses 31-38, wherein the portable financial device transactions comprise a plurality of transactions initiated with a primary account number.

Clause 40: The system of any of clauses 31-39, wherein the at least one subset of users comprises users having a high propensity for prospectively increasing a frequency of portable financial device transactions based at least partially on the at least one predictive model.

Clause 41: A computer program product for segmenting users based on transaction activity and propensity for conducting portable financial device transactions, comprising at least one non-transitory computer-readable medium including program instructions that, when executed by at least one processor cause the at least one processor to: determine at least one subset of transaction data categories from a plurality of transaction data categories; rank the at least one subset of transaction data categories into at least one order; generate at least one predictive model for determining user propensity for prospectively increasing a frequency of portable financial device transactions based at least partially on the ranking of the at least one subset of transaction data categories; analyze transaction data for portable financial device transactions initiated by each user of a plurality of users to identify at least one transaction for each user that corresponds to at least one transaction data category of the at least one subset of transaction data categories; generate at least one subset of users of the plurality of users based at least partially on the at least one predictive model and the at least one transaction identified for each of the plurality of users; and automatically enroll each user in the at least one subset of users in at least one incentive program.

Clause 42: The computer program product of clause 41, comprising a first computer-readable medium and a second computer-readable medium, wherein the first computer-readable medium is located at a transaction service provider and the second computer-readable medium is located remote from the transaction service provider.

Clause 43: The computer program product of clause 41 or 42, wherein ranking the at least one subset of transaction data categories into the at least one order comprises assigning a weight value to each transaction data category of the at least one subset of transaction data categories.

Clause 44: The computer program product of any of clauses 41-43, wherein the at least one subset of transaction data categories comprises a first subset of transaction data categories and a second subset of transaction data categories, wherein the at least one predictive model comprises a first predictive model for users with less than a predefined number of transactions and is generated based at least partially on the first subset of transaction data categories and a second predictive model for users with at least a predefined number of transactions generated based at least partially on the second subset of transaction data categories.

Clause 45: The computer program product of clause 44, wherein the first subset of transaction data categories comprises at least two of: amount of user cash withdrawals, average user international ticket size, user growth momentum of ticket size, days since last user transaction, user withdrawal consistency, and user card type.

Clause 46: The computer program product of clause 44 or 45, wherein the second subset of transaction data categories comprises at least two of: number of user transactions, number of domestic user transactions, user growth momentum of monthly spending, days since last user transaction, number of market categories in which user is active, number of user supermarket transactions, amount of user spending at restaurants, and amount of user spending at gas stations.

Clause 47: The computer program product of any of clauses 41-46, wherein the portable financial device transactions comprise a plurality of transactions initiated with a primary account number.

Clause 48: The computer program product of any of clauses 41-47, wherein the at least one subset of users comprises users having a high propensity for prospectively increasing a frequency of portable financial device transactions based at least partially on the at least one predictive model.

Clause 49: A system for segmenting users based on transaction activity and propensity for conducting portable financial device transactions, comprising: at least one database comprising user transaction data comprising: a plurality of transaction data categories and transaction data for portable financial device transactions initiated by each user of a plurality of users; and at least one processor in communication with the database, the at least one processor programmed or configured to: determine at least one subset of transaction data categories from the plurality of transaction data categories; rank the at least one subset of transaction data categories into at least one order; generate at least one predictive model for determining user propensity for prospectively increasing a frequency of portable financial device transactions based at least partially on the ranking of the at least one subset of transaction data categories; analyze the transaction data for portable financial device transactions initiated by each user of a plurality of users to identify at least one transaction for each user that corresponds to at least one transaction data category of the at least one subset of transaction data categories; generate at least one subset of users of the plurality of users based at least partially on the at least one predictive model and the at least one transaction identified for each of the plurality of users; and automatically enroll each user in the at least one subset of users in at least one incentive program.

Clause 50: The system of clause 49 comprising a first processor and a second processor, wherein the first processor is located at a transaction service provider and the second processor is located remote from the transaction service provider.

Clause 51: The system of clause 49 or 50, wherein ranking the at least one subset of transaction data categories into the least one order comprises assigning a weight value to each transaction data category of the at least one subset of transaction data categories.

Clause 52: The system of any of clauses 49-51, wherein the at least one subset of transaction data categories comprises a first subset of transaction data categories and a second subset of transaction data categories, wherein the at least one predictive model comprises a first predictive model for users with less than a predefined number of transactions and is generated based at least partially on the first subset of transaction data categories and a second predictive model for users with at least a predefined number of transactions generated based at least partially on the second subset of transaction data categories.

Clause 53: The system of clause 52, wherein the first subset of transaction data categories comprises at least two of: amount of user cash withdrawals, average user international ticket size, user growth momentum of ticket size, days since last user transaction, user withdrawal consistency, and user card type.

Clause 54: The system of clause 52 or 53, wherein the second subset of transaction data categories comprises at least two of: number of user transactions, number of domestic user transactions, user growth momentum of monthly spending, days since last user transaction, number of market categories in which user is active, number of user supermarket transactions, amount of user spending at restaurants, and amount of user spending at gas stations.

Clause 55: The system of any of clauses 49-54, wherein the portable financial device transactions comprise a plurality of transactions initiated with a primary account number.

Clause 56: The system of any of clauses 49-55, wherein the at least one subset of users comprises users having a high propensity for prospectively increasing a frequency of portable financial device transactions based at least partially on the at least one predictive model.

Clause 57: A computer program product for segmenting users based on transaction activity and propensity for conducting portable financial device transactions, comprising at least one non-transitory computer-readable medium including program instructions that, when executed by at least one processor cause the at least one processor to: generate a plurality of transaction data categories corresponding to a propensity to increase portable financial device transaction frequency based at least partially on past transaction data; generate and assign weights to each transaction data category of the plurality of transaction data categories based at least partially on the past transaction data; determine a plurality of users having at least one transaction that corresponds to at least one transaction data category of the plurality of transaction data categories; generate a score for each user of the plurality of users based at least partially on transaction data for that user and the weight assigned to the at least one transaction that corresponds to at least one transaction data category of the plurality of transaction data categories; generate at least one subset of users of the plurality of users based at least partially on the score for each user of the plurality of users; and automatically initiate a conversion action to convert at least one user in the at least one subset of users to more frequent performance of portable financial device transactions.

Clause 58: The computer program product of clause 57, comprising a first computer-readable medium and a second computer-readable medium, wherein the first computer-readable medium is located at a transaction service provider and the second computer-readable medium is located remote from the transaction service provider.

Clause 59: The computer program product of clause 57 or 58, wherein the conversion action comprises enrolling each user in the at least one subset of users in at least one incentive program.

Clause 60: The computer program product of any of clauses 57-59, wherein the conversion action comprises generating and/or transmitting a communication to each user in the at least one subset of users.

Clause 61: A system for segmenting users based on transaction activity and propensity for conducting portable financial device transactions, comprising: at least one database comprising user transaction data comprising: a plurality of transaction data categories and past user transaction data; and at least one processor in communication with the database, the at least one processor programmed or configured to: generate a subset of transaction data categories from the plurality of transaction data categories corresponding to a propensity to increase portable financial device transaction frequency based at least partially on the past user transaction data; generate and assign weights to each transaction data category of the subset of transaction data categories based at least partially on the past user transaction data; determine a plurality of users having at least one transaction that corresponds to at least one transaction data category of the subset of transaction data categories; generate a score for each user of the plurality of users based at least partially on past transaction data for that user and the weight assigned to the at least one transaction that corresponds to at least one transaction data category of the subset of transaction data categories; generate at least one subset of users of the plurality of users based at least partially on the score for each user of the plurality of users; and automatically initiate a conversion action to convert at least one user in the at least one subset of users to more frequent performance of portable financial device transactions.

Clause 62: The system of clause 61 comprising a first processor and a second processor, wherein the processor is located at a transaction service provider and the second processor is located remote from the transaction service provider.

Clause 63: The system of clause 61 or 62, wherein the conversion action comprises enrolling each user in the at least one subset of users in at least one incentive program.

Clause 64: The system of any of clauses 61-63, wherein the conversion action comprises generating and/or transmitting a communication to each user in the at least one subset of users.

Clause 65: The method of any of clauses 1-17, wherein the at least one processor analyzes historical transaction data and generates the at least one predictive model based, at least in part, on the historical transaction data.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a schematic diagram of a system for segmenting users based on transaction activity and propensity for conducting portable financial device transactions according to the principles of the present invention;

FIG. 2 is another schematic diagram of a system for segmenting users based on transaction activity and propensity for conducting portable financial device transactions according to the principles of the present invention;

FIG. 3 is another schematic diagram of a system for segmenting users based on transaction activity and propensity for conducting portable financial device transactions according to the principles of the present invention;

FIG. 4 is another schematic diagram of a system for segmenting users based on transaction activity and propensity for conducting portable financial device transactions according to the principles of the present invention;

FIG. 5 is another schematic diagram of a system for segmenting users based on transaction activity and propensity for conducting portable financial device transactions according to the principles of the present invention;

FIG. 6 is another schematic diagram of a system for segmenting users based on transaction activity and propensity for conducting portable financial device transactions according to the principles of the present invention;

FIG. 7 is a step diagram of a method for segmenting users based on transaction activity and propensity for conducting portable financial device transactions;

FIG. 8 is another step diagram of a method for segmenting users based on transaction activity and propensity for conducting portable financial device transactions;

FIG. 9 is another step diagram of a method for segmenting users based on transaction activity and propensity for conducting portable financial device transactions;

FIG. 10A is a process flow diagram for segmenting users based on transaction activity and propensity for conducting portable financial device transactions according to principles of the present invention;

FIG. 10B is a table listing transaction data categories in the subset of transaction data categories, and their respective rankings, in a non-limiting exemplary processes described in FIGS. 10A and 11;

FIG. 11 is another process flow diagram for segmenting users based on transaction activity and propensity for conducting portable financial device transactions according to principles of the present invention; and

FIG. 12 is another process flow diagram for segmenting users based on transaction activity and propensity for conducting portable financial device transactions according to principles of the present invention.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant, a pager, a security card, a computer, an access card, a wireless terminal, and/or a transponder, as examples. The portable financial device may include a volatile or a non-volatile memory to store information, such as an account identifier or a name of the account holder.

As used herein, the terms “issuing institution,” “portable financial device issuer,” “issuer,” or “issuer bank” may be used interchangeably and may refer to one or more entities that provide accounts to customers for conducting payment transactions, such as initiating credit and/or debit payments. For example, an issuing institution may provide an account identifier, such as a personal account number (PAN), to a customer that uniquely identifies one or more accounts associated with that customer. The account identifier may be embodied on a portable financial device such as a physical financial instrument, e.g., a payment card, and/or may be electronic and used for electronic payments. As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they may be used to conduct a transaction without directly using the original account identifier. In some examples, an original account identifier, such as a PAN, may be associated with a plurality of tokens for different individuals or purposes. An issuing institution may be associated with a bank identification number (BIN) that uniquely identifies it. The terms “issuing institution” and “issuing institution system” may also refer to one or more computer systems operated by or on behalf of an issuing institution, such as a server computer executing one or more software applications. For example, an issuing institution system may include one or more authorization servers for authorizing a payment transaction.

As used herein, the term “merchant” refers to an individual or entity that provides goods and/or services, or access to goods and/or services, to customers based on a transaction, such as a payment transaction. Merchant may also refer to one or more computer systems operated by or on behalf of a merchant, such as a server computer executing one or more software applications. As used herein, a “merchant point-of-sale (POS) system” may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that may be used to initiate a payment transaction. A merchant POS system may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases by through an agreement between the transaction service provider and the issuing institution.

Non-limiting embodiments of the present invention are directed to a method, system, and apparatus for segmenting users based on transaction activity and propensity for conducting portable financial device transactions. Portable financial device transactions may refer to transactions initiated with a personal financial device and an account identifier. Non-limiting embodiments of the invention allow for issuing institutions and/or transaction service providers to segment at least one subset of users from a plurality of users to more efficiently target one or more subset of users that have a higher propensity to use their portable financial device to initiate transactions more frequently.

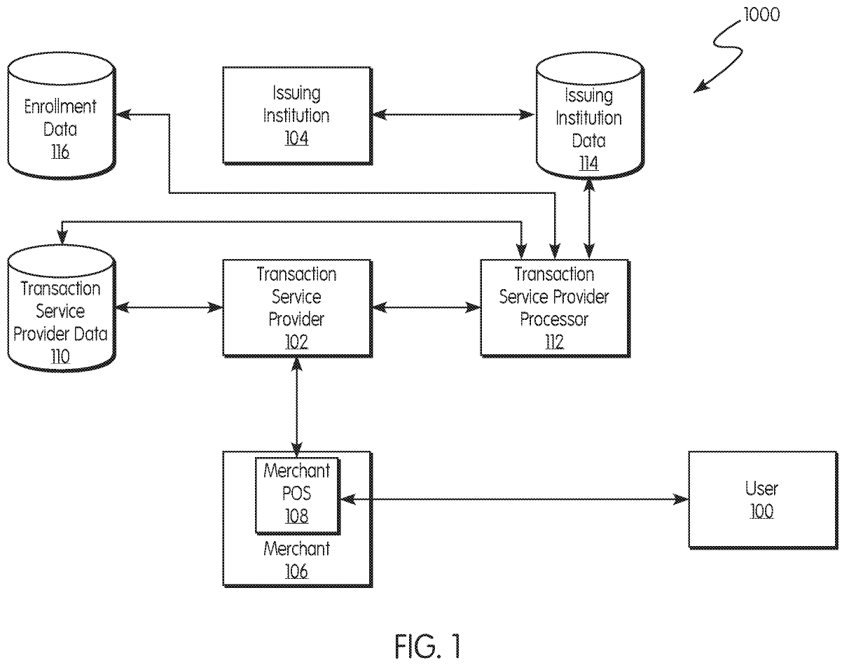

Referring now to FIG. 1, a system 1000 for segmenting users based on transaction activity and propensity for conducting portable financial device transactions is shown according to a non-limiting embodiment. A user 100 may be a holder of a portable financial device (e.g., an account holder) associated with a transaction service provider 102 and issued to the user 100 by an issuing institution 104. In some non-limiting embodiments, the user 100 is a holder of a portable financial device issued by an issuer bank. The user 100 may use the portable financial device to initiate financial transactions with various merchants 106 using a merchant POS 108, which communicates with the transaction service provider 102 to complete payment of the financial transactions. In some non-limiting embodiments, the user 100 may purchase goods or services from the merchant 106 using portable financial device and the merchant POS 108 to guarantee payment for the goods and/or services by authorization requests approved by the transaction service provider 102.

In the example system 1000 shown in FIG. 1, the merchant POS 108 may communicate with the transaction service provider 102 during financial transactions between the user 100 and the merchant 106. During these transactions, the transaction service provider 102 may collect transaction data relating to the financial transactions and communicate that data to a transaction service provider database 110. The transaction service provider database 110 may be located at the transaction service provider 102. Over time, the transaction service provider database 110 may collect historical transaction data (used interchangeably with past transaction data) and other information about a plurality of users who use portable financial devices associated with the transaction service provider 102. For instance, the transaction service provider 102 may collect various information about each of its account holders, including information about each purchase or non-purchase transaction that account holder has made using portable financial device associated with the transaction service provider 102. This historical transaction data may be later analyzed by the transaction service provider 102.

In some non-limiting embodiments, the transaction service provider database 110 may include the following transaction data categories: amount of cash withdrawals using the portable financial device (e.g., ATM withdrawals), date and time of each cash withdrawals using the portable financial device, days since last transaction, location of each cash withdrawal using the portable financial device, average international ticket size, date and time of each international purchase, location of each international purchase, merchant of each international purchase, goods or services bought for each international purchase, increase in amount of withdrawals (growth momentum of ticket size) over a given period (e.g., a month, a year, etc.), number of days since last portable financial device transaction, number of months in which cash was withdrawn using the portable financial device over a given period, number of consecutive months in which cash was withdrawn using the portable financial device over a given period (e.g., withdrawal consistency), portable financial device type (e.g., type of credit/debit card), the overall number of transactions using the portable financial device, the number of domestic transactions using the portable financial device, increase in amount of spending (e.g., growth momentum of monthly spending) over a given period (e.g., a month, a year, etc.), amount spent in each portable financial device transaction, date and time of each portable financial device transaction, merchant involved in each portable financial device transaction, goods and services bought and price of each good or service bought in each portable financial device transaction, category of goods and services bought in each portable financial device transaction, number of market categories active, number of market categories active over a given period, number of supermarket transactions over a given period, amount spent in supermarket transactions over a given period, amount spent at restaurants over a given period, number of restaurant transactions over a given period, amount spent at gas stations over a given period, number of gas station transactions over a given period, amount spent at entertainment merchants over a given period, number of entertainment transactions over a given period, amount spent at automotive merchants over a given period, number of automotive transactions over a given period, amount spent at clothing merchants over a given period, number of clothing transactions over a given period, amount spent on luxury goods over a given period, number of luxury good transactions over a given period, or number of transactions and amount spent for other specific goods or services found to be relevant for projecting an account holder's propensity to more frequently use their portable financial device, number of cash advances using the portable financial device over a given period, amount of cash advances using the portable financial device, credit score, credit score history, and other similar or related metrics regarding use of the portable financial device by the user 100. Any other metric may be included that is determined to be relevant for projecting a cardholder's propensity to use his/her portable financial device more often in the future.

With continued reference to FIG. 1, the example system 1000 may include a transaction service provider processor 112 owned and/or controlled by or on behalf of the transaction service provider 102. The transaction service provider processor 112 may be located at the transaction service provider 102 or elsewhere. The transaction service provider database 110 may be in communication with the transaction service provider 102 and/or the transaction service provider processor 112. In some embodiments, the transaction service provider processor 112 may be a separate computer system or, in other examples, may be a part of the transaction service provider 102. The transaction service provider processor 112 may also be in communication with an issuing institution database 114 which, like the transaction service provider database 110, may include information about each user. The issuing institution database 114 may be located at the issuing institution 104 or elsewhere. The issuing institution database 114 may include information about each user collected by the issuing institution 104. In some non-limiting embodiments, the issuing institution database 114 may include the following information: personal information (e.g., name, age, gender, mailing address, phone number, email address, social security number, driver's license number, marital status, occupation, etc.), and/or various financial information (e.g., credit score, credit score history, bank account number, account identifier, monthly salary, yearly salary, etc.). Some of the information in the transaction service provider database 110 and the issuing institution database 114 may be duplicative.

The transaction service provider processor 112 may also be in communication with an enrollment database 116. In FIG. 1, the enrollment database 116 is maintained by or on behalf of the transaction the transaction service provider 102. In other non-limiting examples, an enrollment database may be maintained by or on behalf of the issuing institution 104, the merchant 106, or other entity. The enrollment database 116 may include information about users that are enrolled in one or more incentive program offered by the transaction service provider 102. Users not currently enrolled in a transaction service provider 102 incentive program may be enrolled in a transaction service provider 102 incentive program by being added to the enrollment database 116 by the transaction service provider processor 112. The enrollment database 116 may also include specific information regarding the incentive programs being offered, such as expiration dates, terms and conditions, etc.

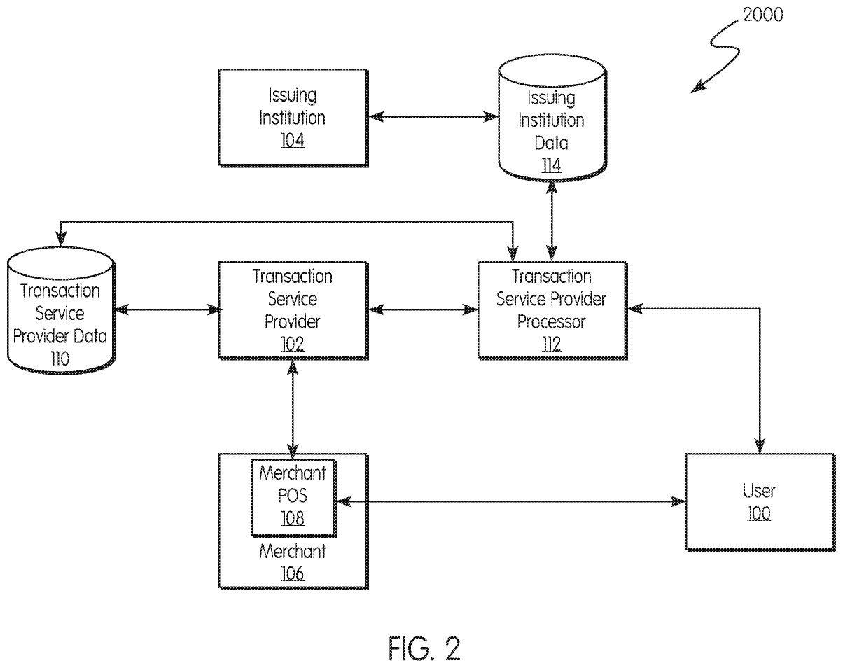

Referring to FIG. 2, a system 2000 for segmenting users based on transaction activity and propensity for conducting portable financial device transactions is shown according to a non-limiting embodiment. The components of the system 2000 in FIG. 2 include all of the capabilities and characteristics of the components from the system 1000 of FIG. 1 having like reference numbers. In a non-limiting embodiment of the system 2000 shown in FIG. 2, the transaction service processor 112 may communicate with the user 100. Such communication may include a web-based communication, an email communication, a text message, a telephone call, a push notification, and/or an instant message. The user 100 may also communicate with the transaction service provider processor 112 using like communication methods.

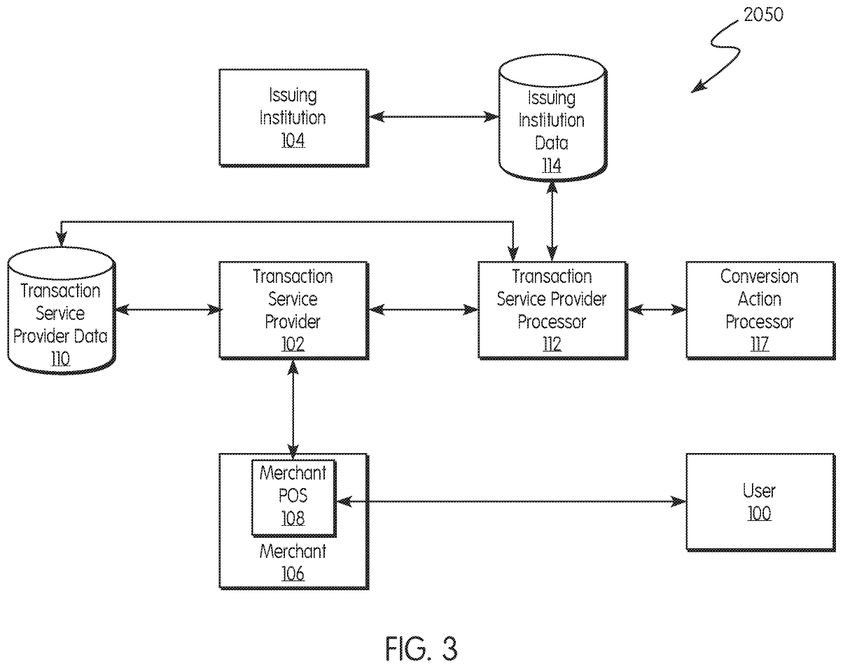

Referring to FIG. 3, a system 2050 for segmenting users based on transaction activity and propensity for conducting portable financial device transactions is shown according to a non-limiting embodiment. The components of the system 2050 in FIG. 3 include all of the capabilities and characteristics of the components from the system 1000 of FIG. 1 having like reference numbers. In a non-limiting embodiment of the system 2050 shown in FIG. 3, the transaction service processor 112 may initiate a conversion action by transmitting a signal to a conversion action processor 117. The conversion action processor 117 may be a separate computer system or, in other examples, may be a part of the transaction service provider processor 112. This conversion action may include automatic enrollment in at least one incentive program or transmitting a communication to a user 100 (as described and shown in FIGS. 1 and 2). A conversion action may also include any other action directed to incentivizing, educating, or encouraging a user 100 in the subset to more frequently use their portable financial device.

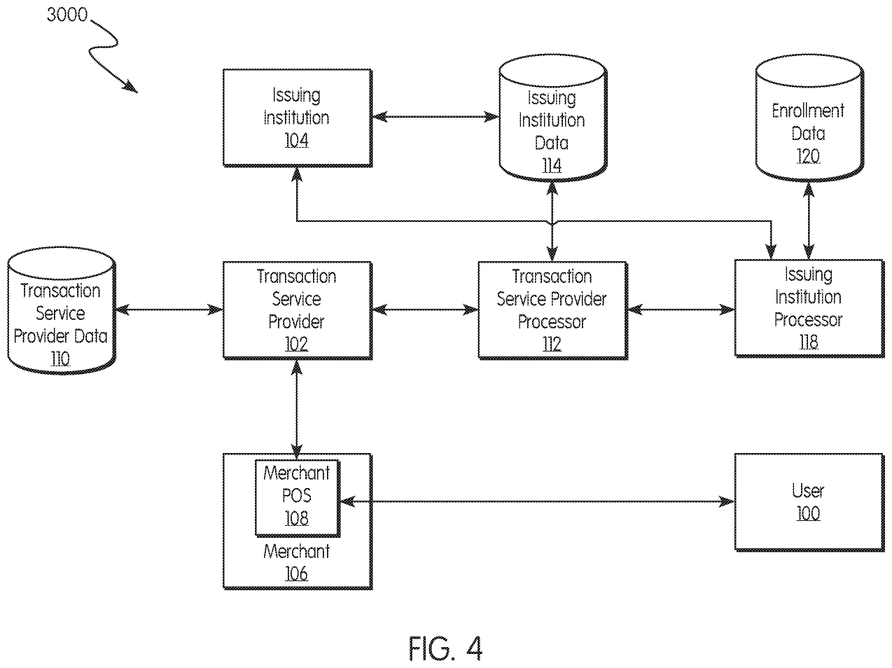

Referring to FIG. 4, a system 3000 for segmenting users based on transaction activity and propensity for conducting portable financial device transactions is shown according to a non-limiting embodiment. The components of the system 3000 shown in FIG. 4 include all of the capabilities and characteristics of the components from the system 1000 of FIG. 1 having like reference numbers. In a non-limiting embodiment of the system 3000 shown in FIG. 4, the transaction service provider processor 112 may be in communication with an issuing institution processor 118. In some embodiments, the issuing institution processor 118 may be a separate computer system from the issuing institution 104 or, in some examples, may be a part of the issuing institution 104. The issuing institution processor 118 may be owned and/or controlled by or on behalf of the issuing institution 104. The issuing institution processor 118 may be located at the issuing institution 104 or elsewhere and may be in communication with the issuing institution 104. The issuing institution processor 118 may be located remotely from the transaction service provider processor 112. The issuing institution processor 118 may also be in communication with an enrollment database 120 of the issuing institution 104. The enrollment database 120 may include information about users that are enrolled in one or more incentive programs offered by the issuing institution 104. Users not currently enrolled in an issuing institution 104 incentive program may be enrolled in an issuing institution 104 incentive program by being added to the enrollment database 120 by the issuing institution processor 118. The enrollment database 120 may also include specific information regarding the incentive programs being offered.

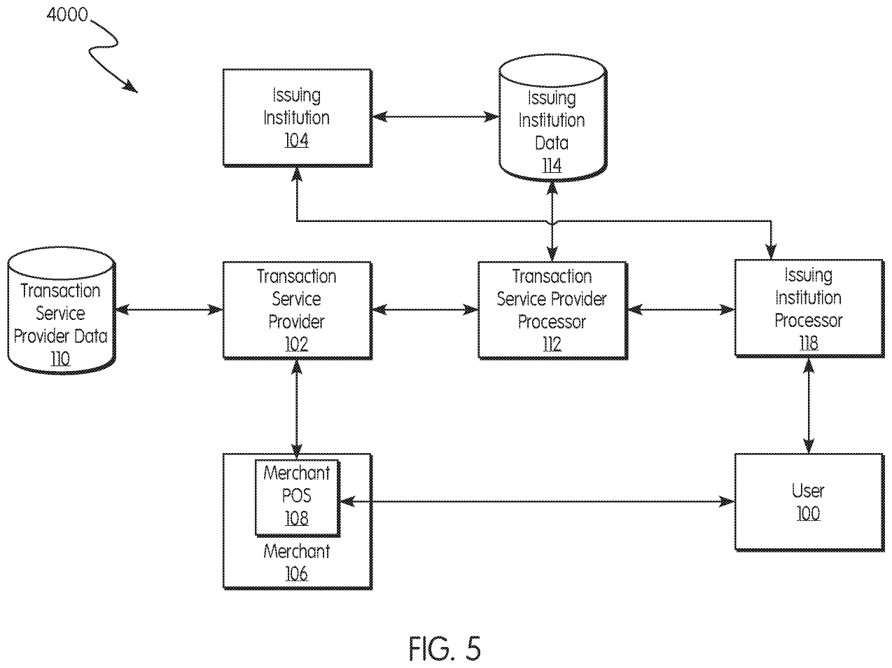

Referring to FIG. 5, a system 4000 for segmenting users based on transaction activity and propensity for conducting portable financial device transactions is shown according to a non-limiting embodiment. The components of the system 4000 shown in FIG. 5 include all of the capabilities and characteristics of the components from the system 3000 of FIG. 4 having like reference numbers. In a non-limiting embodiment of the system 4000 shown in FIG. 5, the issuing institution processor 118 may communicate with the user 100. Such communication may include a web-based communication, an email communication, a text message, a telephone call, a push notification, and/or an instant message. The user 100 may also communicate with the issuing institution processor 118 using like communication methods.

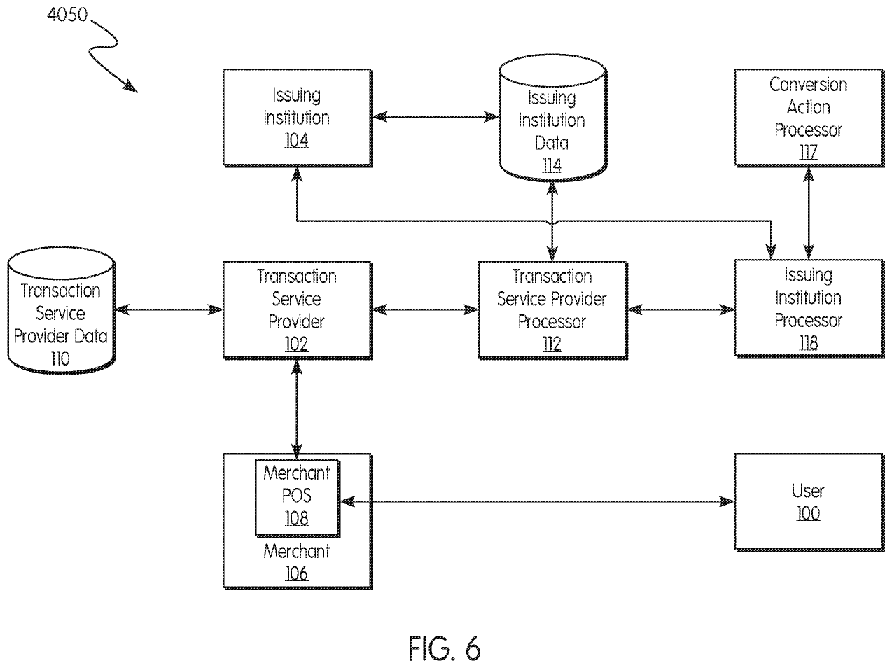

Referring to FIG. 6, a system 4050 for segmenting users based on transaction activity and propensity for conducting portable financial device transactions is shown according to a non-limiting embodiment. The components of the system 4050 shown in FIG. 6 include all of the capabilities and characteristics of the components from the system 3000 of FIG. 4 having like reference numbers. In a non-limiting embodiment of the system 4050 shown in FIG. 6, the issuing institution processor 118 may initiate a conversion action using the conversion action processor 117. The conversion action processor 117 may be a separate computer system or, in other examples, may be a part of the issuing institution processor 118. This conversion action may include automatic enrollment in at least one incentive program or transmitting a communication to a user 100 (as described and shown in FIGS. 4 and 5). A conversion action may also include any other action directed to incentivizing, educating, or encouraging a user 100 in the subset to more frequently use their portable financial device.

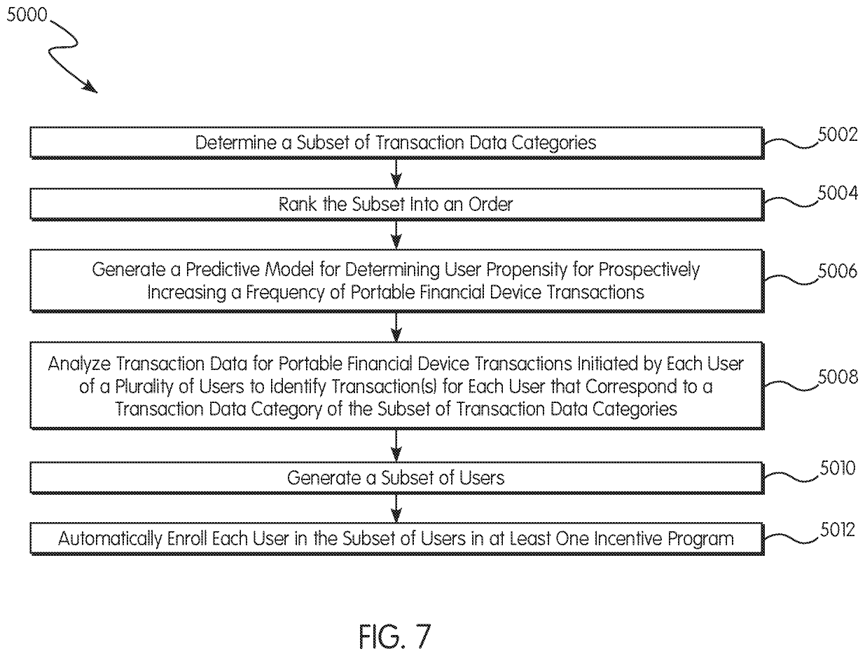

Referring to FIG. 7, a method 5000 is shown for segmenting users based on transaction activity and propensity for conducting portable financial device transactions. The method includes a step 5002 of determining at least one subset of transaction data categories from a plurality of transaction data categories. At step 5004, ranking the at least one subset of transaction data categories into at least one order is performed. At step 5006, generating, with at least one processor, at least one predictive model for determining user propensity for prospectively increasing a frequency of portable financial device transactions based at least partially on the ranking of the at least one subset of transaction data categories is performed. At step 5008, analyzing, with at least one processor, transaction data for portable financial device transactions initiated by each user of a plurality of users to identify at least one transaction for each user that corresponds to at least one transaction data category of the at least one subset of transaction data categories is performed. At step 5010, generating, with at least one processor, at least one subset of users of the plurality of users based at least partially on the at least one predictive model and the at least one transaction identified for each of the plurality of users is performed. At step 5012, automatically enrolling, with at least one processor, each user in the at least one subset of users in at least one incentive program is performed.

With continued reference to FIG. 7, and referring back to FIG. 1, step 5002 may include determining relevant transaction data categories to determine a subset of transaction data categories from a plurality of transaction data categories. The transaction data categories may be extracted or derived from any of the information included in the transaction service provider database 110 and/or the issuing institution database 114, as previously described. The transaction service provider processor 112 may, at least in part, determine which of the transaction data categories belong in the subset of transaction data categories. The subset of transaction data categories may include any number of transaction data categories. In some non-limiting embodiments, the subset of transaction data categories includes only a select number of transaction data categories from the transaction data categories. In some non-limiting embodiments, the subset of transaction data categories includes all of the transaction data categories. The select transaction data categories may include only the transaction data categories deemed most relevant, such as the 15 most relevant transaction data categories, the 10 most relevant transaction data categories, the 8 most relevant transaction data categories, the 5 most relevant transaction data categories. Relevant transaction data categories may, in this example, mean the most influential transaction data categories for predicting users that have a higher propensity to use their portable financial device to initiate transactions more frequently.

With continued reference to FIG. 7, and referring back to FIG. 1, step 5004 may include ranking the subset of transaction data categories into an order based on which transaction data categories are expected to be more relevant for predicting users that have a higher propensity to use their portable financial device to initiate transactions more frequently relative to the other transaction data categories in the subset. This ranking may be performed, at least in part, by the transaction service provider processor 112. However, it will be appreciated that the ranking may be performed by any entity. Step 5004 may result in each transaction data category in the subset being ranked as either more or less important than the other transaction data categories in the subset. In some non-limiting embodiments, at least one transaction data category may receive the same ranking as at least one other transaction data category. In some non-limiting embodiments, the step 5004 may include a list of the transaction data categories in the subset from most relevant to least relevant (or vice versa). In some non-limiting embodiments, each transaction data category may be assigned a weight which represents its relevance relative to the other transaction data categories in the subset. For example, for a subset having a transaction data category A and a transaction data category B it may be determined that a higher amount of transaction activity in Category A or Category B (such as a higher transaction amount, higher transaction frequency, etc.) correlates with a higher user propensity to use their portable financial device to initiate transactions more frequently. For example, it may be further determined that Category A correlates more strongly than Category B regarding user propensity to use their portable financial device to initiate transactions more frequently. Thus, Category A may receive a higher ranking than Category B.

With continued reference to FIG. 7, and referring back to FIG. 1, step 5006 may include generating with the transaction service provider processor 112 at least one predictive model. The predictive model may be used to determine user propensity to use their portable financial device to initiate transactions more frequently. This predictive model may be generated by the transaction service processor 112 using data from the transaction service provider database 110, such as historical transaction data, and/or the issuing institution database 114, the subset of transaction data categories, and the ranking of those transaction data categories. In some non-limiting embodiments, the transaction service provider processor 112 analyzes historical transaction data and generates the predictive model based, at least in part, on the analyzed historical transaction data. It will be appreciated that the predictive model may be generated by any entity.

More than one predictive model may be generated in step 5006. In some non-limiting embodiments, the at least one subset of transaction data categories may include a first and a second subset of transaction data categories. The first subset of transaction data categories may be used to generate, at least in part, a first predictive model. This first predictive model may apply to users having less than a predefined number of transactions. The second subset of transaction data categories may be used to generate, at least in part, a second predictive model. This second predictive model may apply to users having at least a predefined number of transactions. The predefined number of transaction data categories may, in some embodiments, be a single transaction (other than a cash withdrawal using the portable financial device), such that the first predictive model applies to users who have not completed a single transaction with their personal financial device and the second predictive model applies to users who have completed one or more transactions with their personal financial device. Therefore, the first predictive model may apply to users who have not used their personal financial device but show a propensity to use their personal financial device to initiate transactions more frequently. Further, the second predictive model may apply to users who have, at some point, used their personal financial device and show a propensity to use their portable financial device to initiate transactions more frequently. In other non-limiting embodiments, the predefined number may be several transactions such that users who have not used their personal financial devices more than several times still fall within the first predictive model. In other non-limiting embodiments, the predefined number may be a rate of using the personal financial device (e.g., number of times used over a period of time) such that only users who more frequently used their personal financial device over a given time period are analyzed with the second predictive model. For example, the predefined number may be one transaction per month, such that those who average 1.0 or more transactions per month are analyzed with the second predictive model and users who average less than 1.0 transactions per month are analyzed with the first predictive model. In some non-limiting embodiments, the first subset of transaction data categories may include: amount of cash withdrawals, average international ticket size, growth momentum of ticket size, days since last transaction, withdrawal consistency, and card type. In some non-limiting embodiments, the first subset of transaction data categories may include: number of transactions, number of domestic transactions, growth momentum of monthly spending, days since last transaction, number of market categories active, number of supermarket transactions, amount of spending at restaurants, and amount of spending at gas stations.

With continued reference to FIG. 7, and referring back to FIG. 1, step 5008 may include analyzing transaction data associated with each user to identify transactions for each user that correspond to the subset of transaction data categories. This may include the transaction service provider processor 112 analyzing information user-by-user from the transaction service provider database 110 and/or the issuing institution database 114 to associate the user 100 with the subset of transaction data categories. This may include analyzing how the user 100 uses their portable financial device in connection with the subset of transaction data categories.

With continued reference to FIG. 7, and referring back to FIG. 1, step 5010 may include generating a subset of users of the plurality of users based on the predictive model and the transactions identified for each user of the plurality of users. In some non-limiting embodiments, the subset of users includes users that have a higher propensity to use their portable financial device to initiate transactions more frequently. The subset of users may include all users in the plurality of users or only a select subset of users in the plurality of users. The users may be ranked relative to the other users (using a score or other ranking method) based on their expected higher propensity to use their portable financial device to initiate transactions more frequently relative to the other users. In some non-limiting embodiments, the subset may include only the top 10% of users of the plurality of users considered to have a higher propensity to use their portable financial device to initiate transactions more frequently relative to the other users. This may be based on the ranking of the users, such that only the top 10% of the ranked users are included in the subset. In other non-limiting embodiments, the subset may include only the top 15%, top 20%, the top 25%, the top 30%, the top 33%, the top 35%, the top 40%, the top 45%, the top 50%, the top 55%, the top 60%, the top 65%, the top 67%, the top 70%, the top 75%, the top 80%, the top 85%, the top 90%, or the top 95% of users in the plurality of users, as examples. It will be appreciated that any percentage of users may be included in a particular subset.

In some non-limiting embodiments, step 5010 may include generating a plurality of subsets of users. For example, the plurality of users may be broken into a plurality of subsets of users based on their expected higher propensity to use their portable financial device to initiate transactions more frequently relative to the other users. Each user may be assigned to only one of the plurality of subsets or, in other examples, there may be an overlap of users in the plurality of subsets (e.g., users may be included in multiple subsets). In some non-limiting embodiments, each user in the plurality of users may be assigned to one of three subsets based on their expected higher propensity to use their portable financial device to initiate transactions more frequently relative to the other users. The users in the top one-third of users may be assigned to a first, high propensity subset, the middle one-third of users may be assigned to a second, medium propensity subset, and the bottom one-third of users may be assigned to a third, low propensity subset. It will be appreciated that any number of subsets may be used. The high propensity users may refer to users having a higher propensity to use their portable financial device to initiate transactions more frequently based at least partially on the predictive model. Higher propensity users are more likely to increase their use of their portable financial device relative to other users. Users may be segmented similarly into halves, quarters, one-fifths, etc., into the desired number of user segments based on their expected higher propensity to use their portable financial device to initiate transactions more frequently relative to the other users. It will be appreciated that equal groups containing identical numbers of users (e.g., halves, thirds, etc.) are not required. For instance, some non-limiting embodiments may include high propensity users being the top 30% of users, medium propensity users being the middle 30% of users, and low propensity users being the bottom 40% of users.

With continued reference to FIG. 7, and referring back to FIG. 1, step 5012 may include the transaction service provider processor 112 automatically enrolling each user of at least one subset of users in at least one incentive program by communicating with the transaction service provider's 102 enrollment database 116. The incentive program may include any program that provides a benefit to the user. The benefit may be provided to the user contingent on past, present, or future use of their portable financial device. The benefit may be in the form of a discount, coupon, cash back, promotional item, sweepstakes, or any other incentive to the user 100. More than one subset of users may be automatically entered into incentive program(s) by the transaction service provider processor 112 based on a request from the transaction service provider 102. The subset of users may be entered into one or multiple incentive programs. The subset of users entered into the incentive program(s) may include those users having an expected higher propensity to use their portable financial device to initiate transactions more frequently relative to the other users in order to entice and/or incentivize those users to use their portable financial devices to initiate transactions more frequently. In some non-limiting embodiments, automatically enrolling in the incentive program may cause a benefit to be transmitted to a mobile device of the user, such as but not limited to a voucher in an electronic wallet application.

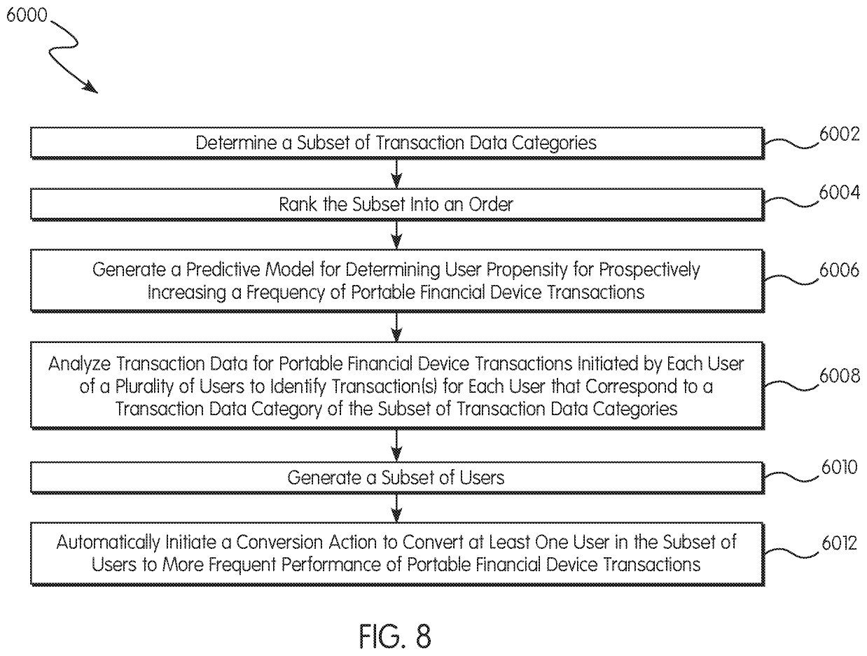

Referring to FIG. 8, a method 6000 of segmenting users based on transaction activity and propensity for conducting portable financial device transactions is shown. The method includes a step 6002 in which determining at least one subset of transaction data categories from a plurality of transaction data categories is performed. At step 6004, ranking the at least one subset of transaction data categories into at least one order is performed. At step 6006, generating, with at least one processor, at least one predictive model for determining user propensity for prospectively increasing a frequency of portable financial device transactions based at least partially on the ranking of the at least one subset of transaction data categories is performed. At step 6008, analyzing, with at least one processor, transaction data for portable financial device transactions initiated by each user of a plurality of users to identify at least one transaction for each user that corresponds to at least one transaction data category of the at least one subset of transaction data categories is performed. At step 6010, generating, with at least one processor, at least one subset of users of the plurality of users based at least partially on the at least one predictive model and the at least one transaction identified for each of the plurality of users is performed. At step 6012, automatically initiating, with at least one processor, a conversion action to convert at least one user in the at least one subset of users to more frequent performance of portable financial device transactions is performed.

With continued reference to FIG. 8, and referring back to FIG. 7, step 6002, step 6004, step 6006, step 6008, and step 6010 may correspond to step 5002, step 5004, step 5006, step 5008, and step 5010, respectively, from the method of FIG. 7 (as described above).

With continued reference to FIG. 8, and referring back to FIGS. 1, 2, and 5, step 6012 may include automatically initiating a conversion action to convert at least one user in the subset of users to more frequently use their portable financial device. This conversion action may include automatic enrollment in at least one incentive program as described in step 5012 from FIG. 7. In other non-limiting embodiments, the conversion action may include generating and/or transmitting a communication to each user in the at least one subset of users. The communication may include information regarding use of their portable financial device, including the benefits of using the portable financial device. The communication may also include an offer to enter at least one incentive program as described above. This communication may be sent in combination with automatically enrolling the user 100 in an incentive program (i.e., a notification communication notifying the user 100 of enrollment in an incentive program). The communication may be automatically generated and sent to the user 100 by the transaction service provider processor 112. The communication may take any communication form, including a web-based communication, an email communication, a text message, a telephone call, a push notification, and/or an instant message. The communication may be sent to one or multiple subsets of users. The user 100 may respond to the communication. A conversion action may also include any other action directed to incentivizing, educating, or encouraging a user 100 in the subset to more frequently use their portable financial device. The conversion action may be initiated by the conversion action processor 117.

Referring back to FIGS. 3-6 and 8, in some non-limiting embodiments, steps 5012 or 6012, as described above, may instead or additionally be performed by the issuing institution processer 118. The issuing institution processor 118 may be in communication with the transaction service provider processor 112 to receive information from the transaction service provider processor 112, such as the rank of the subset of transaction data categories, the generated predictive model, the analysis of the portable financial transaction data for each user, or the generated subset(s) of users. The issuing institution processor 118, from the information received from the transaction service provider processor 112, may initiate the previously described conversion action. In other words, the issuing institution processor 118 may automatically enroll at least one subset of users in an issuing institution 104 incentive program by communicating with the issuing institution 104 enrollment database 120. In other non-limiting examples, the issuing institution processor 118 may communicate with the user 100, as described above. Further, it will be appreciated that the issuing institution processor 118 may take any other action directed to incentivizing, educating, or encouraging a user 100 in the subset of users to more frequently use their portable financial device, as described above. The issuing institution processor 118 may communicate with the conversion action processor 117 to institute the conversion action. It is to be understood that the transaction service provider processor 112 and/or the issuing institution processor 118 may automatically initiate the conversion action(s).

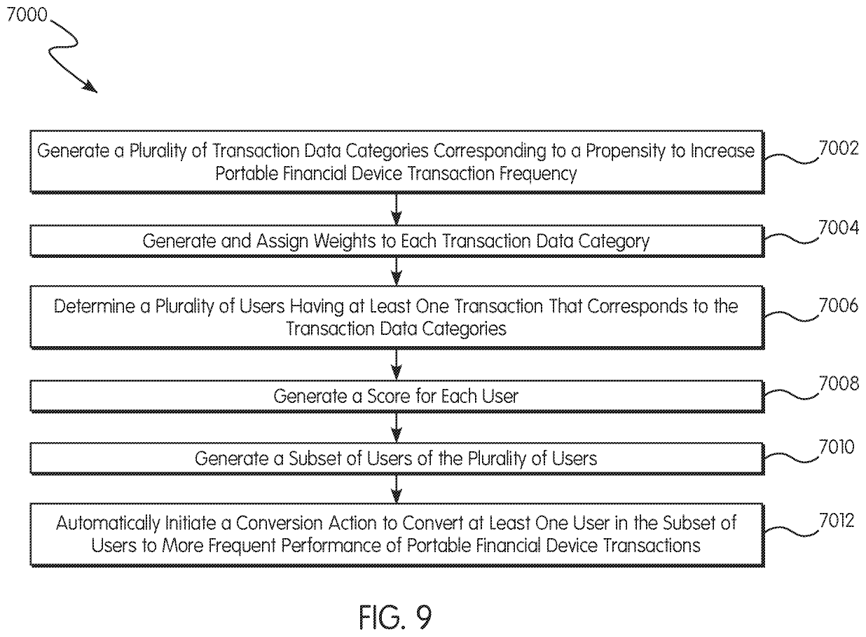

Referring to FIG. 9, a method 7000 of segmenting users based on transaction activity and propensity for conducting portable financial device transactions is shown. the method includes a step 7002 in which generating a plurality of transaction data categories corresponding to a propensity to increase portable financial device transaction frequency based at least partially on past transaction data is performed. At step 7004, generating and assigning weights to each transaction data category of the plurality of transaction data categories based at least partially on the past transaction data is performed. At step 7005, determining, with at least one processor, a plurality of users having at least one transaction that corresponds to at least one transaction data category of the plurality of transaction data categories is performed. At step 7008, generating, with at least one processor, a score for each user of the plurality of users based at least partially on transaction data for that user and the weight assigned to the at least one transaction that corresponds to at least one transaction data category of the plurality of transaction data categories is performed. At step 7010, generating, with at least one processor, at least one subset of users of the plurality of users based at least partially on the score for each user of the plurality of users is performed. At step 7012 automatically initiating, with at least one processor, a conversion action to convert at least one user in the at least one subset of users to more frequent performance of portable financial device transactions is performed.

With continued reference to FIG. 9, and referring back to FIGS. 1-4, step 7002 may include generating a plurality of transaction data categories that correspond to user propensity to use their portable financial device to initiate transactions more frequently based at least partially on past transaction data. This step 7002 may be performed by the transaction service provider processor 112. Information regarding the plurality of transaction data categories and past transaction data for portable financial device transactions initiated by each user of a plurality of users may be stored in the transaction service provider database 110 and/or the issuing institution database 114 and may include any of the previously-described information in these databases. The past transaction data may indicate which of the categories of information stored therein are relevant or correspond to user propensity to use their portable financial device to initiate transactions more frequently. The relevant transaction data categories may be included in the plurality of transaction data categories generated by step 7002. The plurality of transaction data categories may include any number of transaction data categories. The plurality of transaction data categories may include only the transaction data categories deemed most relevant, such as the 15 most relevant transaction data categories, the 10 most relevant transaction data categories, the 8 most relevant transaction data categories, or the 5 most relevant transaction data categories.

With continued reference to FIG. 9, and referring back to FIGS. 1-6, step 7004 may include generating and assigning weights to each transaction data category in the plurality of transaction data categories. This step 7004 may be performed by the transaction service provider processor 112. The weights generated and assigned to each transaction data category may be based, at least in part, on the past transaction data. The past transaction data may indicate which of the transaction data categories are more relevant relative to the other transaction data categories. From this indication, a relative weight may be assigned to each of the categories in the plurality of transaction data categories to more accurately consider each transaction data category with respect to that category's likelihood in indicating a user's higher propensity to use their portable financial device to initiate transactions more frequently. For example, in a plurality of transaction data categories including a Category A and a Category B, the past transaction data may indicate that Category A is more likely to indicate a user's propensity to more frequently use their portable financial compared to Category B. Thus, Category A may be assigned a higher weight compared to Category B.

With continued reference to FIG. 9, and referring back to FIGS. 1-6, step 7006 may include determining a plurality of users having at least one transaction corresponding to at least one transaction data category of the plurality of transaction data categories. Step 7006 may be performed by the transaction service provider processor 112. Step 7006 may include analyzing the past transaction data for each user stored in the transaction service provider database 110 or issuing institution database 114 to determine for each user whether any of that user's past transaction data corresponds to the plurality of transaction data categories.

With continued reference to FIG. 9, and referring back to FIGS. 1-6, step 7008 may include generating a score for each user. The transaction service provider processor 112 may generate the score for each user. It will be appreciated that the score may be generated by any other entity. Each user's score may be generated based on that user's transaction data and the weight assigned to the transaction data categories for which that user has transaction data for the plurality of transaction data categories. A score may be generated for every user having transaction data for the plurality of transaction data categories. The score may indicate expected user propensity to use their portable financial device to initiate transactions more frequently.

With continued reference to FIG. 9, and referring back to FIGS. 1-6, step 7010 may consider the scores for each of the users and generate a subset of users based at least partially on those scores. The transaction service processor 112 may generate the subset of users. The subset of users may include all users in the plurality of users or only a select subset of users in the plurality of users. The users may be ranked relative to the other users based on the score of each user. In some non-limiting embodiments, the subset may include only the top 10% of users of the plurality of users considered to have a higher propensity to use their portable financial device to initiate transactions more frequently relative to the other users (e.g., the top 10% of users having the highest score). In other words, the subset may include a subset of users, such that only the top 10% of the ranked users are included in the subset. In other non-limiting embodiments, the subset may include only the top 15%, top 20%, the top 25%, the top 30%, the top 33%, the top 35%, the top 40%, the top 45%, the top 50%, the top 55%, the top 60%, the top 65%, the top 67%, the top 70%, the top 75%, the top 80%, the top 85%, the top 90%, or the top 95% of users in the plurality of users, as examples. It will be appreciated that any percentage of users may be included in a particular subset.

In some non-limiting embodiments, step 7010 may include generating a plurality of subsets of users. For example, the plurality of users may be segmented into a plurality of subsets of users based on their expected propensity to use their portable financial device to initiate transactions more frequently relative to the other users. Each user may be assigned to only one of the plurality of subset or there may be overlap in users in the plurality of subsets. Each user may be assigned to one of three subsets based on their expected propensity to use their portable financial device more frequently relative to the other users. It will be appreciated that any number of subsets may be used. The users in the top one-third of users (based on score) may be assigned to a first, high propensity subset, the middle one-third of users (based on score) may be assigned to a second, medium propensity subset, and the bottom one-third of users (based on score) may be assigned to a third, low propensity subset. Users may be broken down similarly into halves, quarters, one-fifths, etc., into the desired number of user segments based on their expected propensity to use their portable financial device to initiate transactions more frequently relative to the other users. It will be appreciated that equal groups containing identical numbers of users (e.g., halves, thirds, etc.) are not required. For instance, some non-limiting embodiments may include high propensity users being the top 30% of users, medium propensity users being the middle 30% of users, and low propensity users being the bottom 40% of users.

With continued reference to FIG. 9, and referring back to FIGS. 1-8, step 7012 may include initiating a conversion action to convert at least one user in the subset of users to more frequent performance of portable financial device transactions. Step 7012 may correspond to step 6012 from the method 6000 shown in FIG. 8 and described above. In addition, as previously described, step 7012 may be performed by the transaction service provider processor 112 and/or the issuing institution processor 118. The issuing institution processor 118 may be located remote from the transaction service provider processor 112. In other words, referring back to FIGS. 4-5 and 7-8, in some non-limiting embodiments, step 7012, as described above, may instead or additionally be performed by the issuing institution processer 118. The issuing institution processor 118 may be in communication with the transaction service provider processor 112 to receive information from the transaction service provider processor 112, such as the weights assigned to each of the transaction data categories, the score for each user, or the subset(s) of users. The issuing institution processor 118, from the information received from the transaction service provider processor 112, may initiate the previously described conversion action. In other words, the issuing institution processor 118 may automatically enroll at least one subset of users in an issuing institution 104 incentive program by communicating with the issuing institution 104 enrollment database 120. In some non-limiting embodiments, the issuing institution processor 118 may communicate with the user 100, as described above. It will be appreciated that the issuing institution processor 118 may take any other action directed to incentivizing, educating, or encouraging a user 100 in the subset to more frequently use their portable financial device, as described above. It is to be understood that the transaction service provider processor 112 and/or the issuing institution processor 118 may automatically initiate the conversion action(s). The transaction service provider processor 112 or the issuing institution processor 118 may communicate with the conversion action processor 117 to initiate the conversion action.

In a further, non-limiting embodiment, a computer program product for segmenting users based on transaction activity and propensity for conducting portable financial device transactions includes at least one non-transitory computer readable medium including program instructions that, when executed by at least one processor, cause the at least one processor to execute one of the previously-described methods (e.g., method 5000, method 6000, or method 7000). The at least one processor may include the transaction service provider processor 112, the issuing institution processor 118, and/or the conversion action processor 117.

The computer program product may include a plurality of computer-readable media, such as a first computer-readable medium and a second compute readable medium. The first computer-readable medium may be located at a transaction service provider 102. The second computer-readable medium may be located remote from the transaction service provider 102, such as at the issuing institution 104.

### Examples

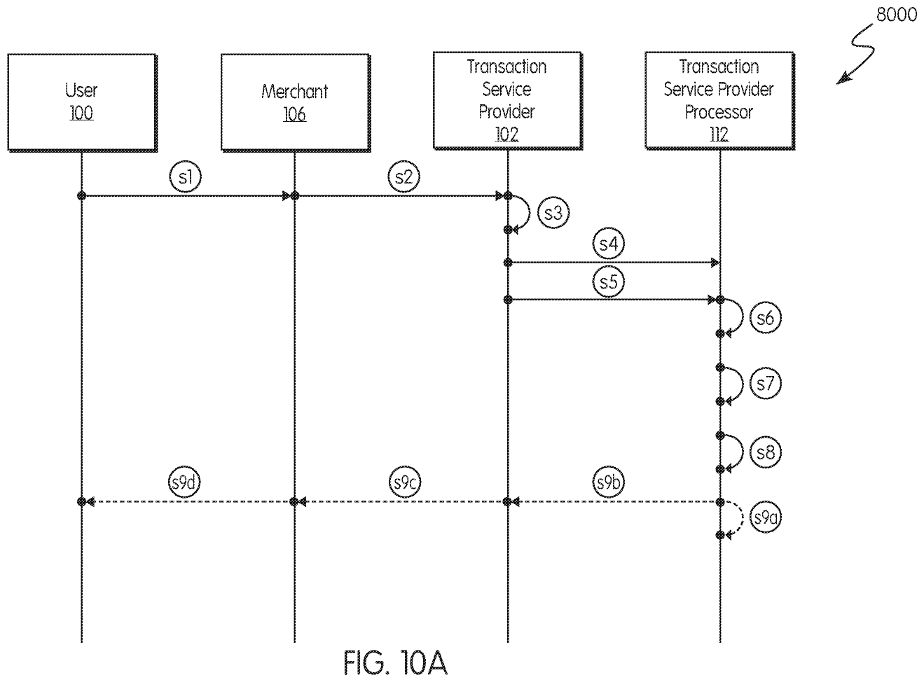

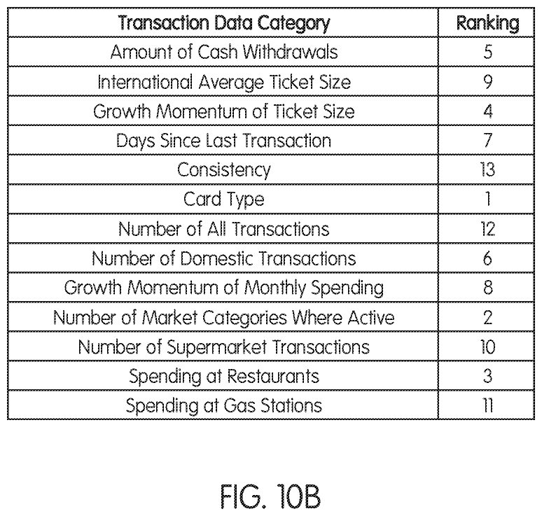

Referring to FIG. 10A, a process flow diagram shows an exemplary process 8000 for segmenting users based on transaction activity and propensity for conducting portable financial device transactions. It will be appreciated that the steps shown in the process flow diagram are for exemplary purposes only and that in various non-limiting embodiments, additional or fewer steps maybe performed to segment users. At a first step (s1), a user 100 initiates and completes a financial transaction using a portable financial device associated with the transaction service provider 102 issued by the issuing institution 104. The transaction may be a withdrawal from an ATM or it may be a financial transaction with a merchant 106 having a merchant POS 108, as examples. In the case of a financial transaction with a merchant 106 having a merchant POS 108 (shown in FIG. 10A), the user 100 provides information from his/her personal financial device, such as an account identifier (e.g., 16-digit PAN), to complete a financial transaction in exchange for goods or services offered by the merchant 106. The merchant POS 108, in response, processes the transaction. At a second step (s2), the merchant 106, through the merchant POS 108, sends transaction data concerning the financial transaction between the merchant 106 and the user 100 to the transaction service provider 102. In some non-limiting embodiments, the merchant POS 108 sends the information to a transaction processor (not shown) of the transaction service provider 102. Information sent to the transaction service provider 102 may include: date and time of the transaction, location of the transaction, amount of the transaction, type of goods or services purchased, and/or the like. The transaction processor may, in some cases, be the same processor as the transaction service provider processor 112, or it may be a separate processor associated with the transaction service provider 102. If the transaction by the user 100 is an ATM transaction (e.g., withdrawal), the information regarding the withdrawal may be sent to the transaction service provider 102. Information in this situation may include for example: date and time of transaction, amount of withdrawal, location of withdrawal, and/or other like transaction data. At a third step (s3), the transaction service provider 102 relays the information collected regarding the user's transactions to a transaction service provider database 110 owned and/or controlled by or on behalf of the transaction service provider 102. The first through third steps of FIG. 10A (s1-s3) may be performed for any number of transactions for a particular user 100 and may be performed for all transactions by any number of users who are account holders of the transaction service provider 102.

With continued reference to FIG. 10A, the transaction service provider 102 determines a subset of transaction data categories from a plurality of transaction data categories in a fourth step (s4). The subset of transaction data categories includes the transaction data categories the transaction service provider 102 has determined to be most relevant for projecting user propensity to use their portable financial device to initiate transactions more frequently. The determination of the subset of transaction data categories may be determined by the transaction service provider processor 112 in some non-limiting embodiments. In some non-limiting embodiments, the subset of transaction data categories includes those transaction data categories shown in the table in FIG. 10B. For instance, the subset of transaction data categories in this example include: amount of cash withdrawals, international average ticket size, growth momentum of ticket size, days since last transaction, consistency, card type, number of all transactions, number of domestic transactions, growth momentum of monthly spending, number of market categories where active, number of supermarket transactions, spending at restaurants, and spending at gas stations. The transaction service provider 102 sends the subset of transaction data categories to the transaction service provider processor 112. At a fifth step (s5), the transaction service provider 102 ranks the subset of transaction data categories into an order. In some non-limiting embodiments, the ranking may be performed by the transaction provider processor 112. The ranking indicates the order of importance determined by the transaction service provider 102 of each of the transaction data categories in the subset of transaction data categories based on the determined ability of each transaction data categories to project user propensity to use their portable financial device to initiate transactions more frequently. Weights may be assigned to each of the transaction data categories. A non-limiting example of a ranking of transaction data categories is shown in FIG. 10B. For instance, transaction data categories shown in FIG. 10B are ranked in the following order of relevance: (1) card type, (2) number of market categories where active, (3) spending at restaurants, (4) growth momentum of ticket size, (5) amount of cash withdrawals, (6) number of domestic transactions, (7) days since last transaction, (8) growth momentum of monthly spending, (9) international average ticket size, (10) number of supermarket transactions, (11) spending at gas stations, (12) number of all transactions, and (13) consistency. The transaction service provider 102 sends the ranking of the transaction data categories to the transaction service provider processor 112.

With continued reference to FIG. 10A, at a sixth step (s6) the transaction service provider processor 112 generates or modifies and existing predictive model for determining user propensity to use their portable financial device to initiate transactions more frequently. The predictive model is determined by the transaction service provider processor 112 based in part of the transaction data categories in the subset of transaction data categories, including the ranking for each of the transaction data categories. It will be appreciated that the predictive model may already exist. At a seventh step (s7), the transaction service provider processor 112 analyzes transaction data for portable financial device transactions initiated by each user that is a cardholder of the transaction service provider 102. The transaction data is retrieved by the transaction service provider processor from the transaction service provider database 110 (previously described). Information may also be retrieved, if relevant, from an issuing institution database 114, which may contain other information about the users. At an eighth step (s8), the transaction service provider processor 112 generates a subset of users based on the predictive model and the transactions analyzed for each user. The subset of users generated by the transaction service provider processor 112 includes a list of users who are considered to have the highest propensity to use their portable financial device to initiate transactions more frequently.

With continued reference to FIG. 10A, at a ninth step (s9a-s9d), the transaction service provider processor 112 automatically initiates a conversion action relating to the subset of users generated in the eighth step (s8). As previously described, a conversion action may include any action directed to incentivizing, educating, or encouraging a user 100 in the subset to more frequently use their portable financial device. The conversion action may be performed by the transaction service provider processor 112 to automatically enroll users in the subset of users in at least one incentive program (s9a). The conversion action may be performed by the transaction service provider processor 112 to automatically transmit the subset of users to the transaction service provider 102 (s9b) to incentivize, educate, or encourage a user 100 in the subset to more frequently use their portable financial device. The conversion action may be performed by the conversion action processor 117 and/or transaction service provider processor 112 by automatically transmitting the subset of users to the merchant 106 (s9c) to incentivize, educate, or encourage a user 100 in the subset to more frequently use their portable financial device. The conversion action may be performed by the transaction service provider processor 112 and/or the conversion action processor 117 by automatically transmitting a communication to the users in the subset of users (s9d).

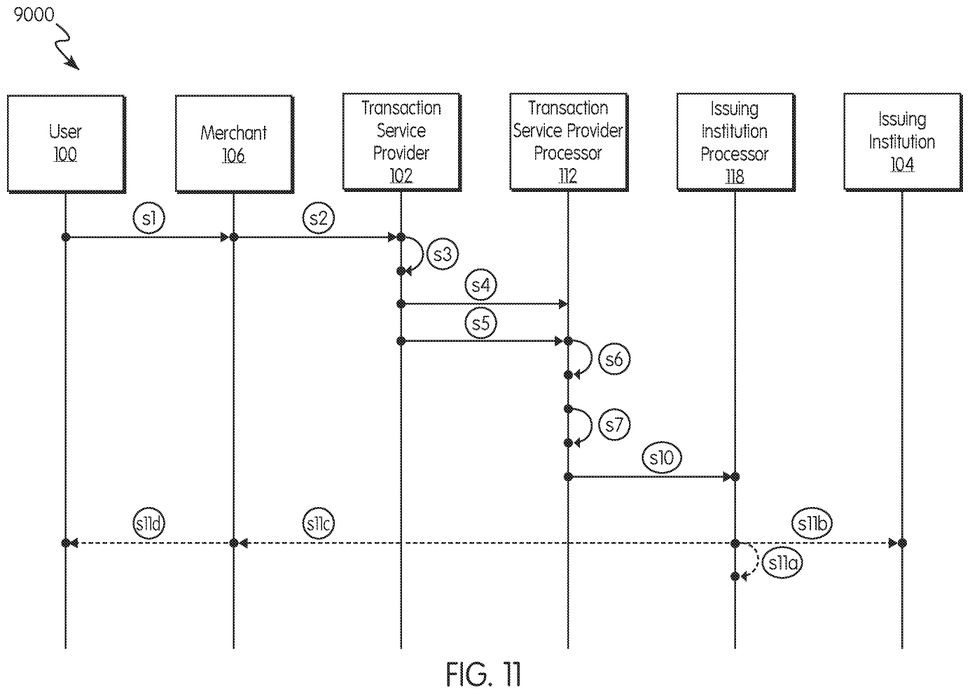

Referring to FIG. 11 a process flow diagram shows an exemplary process 9000 for segmenting users based on transaction activity and propensity for conducting portable financial device transactions. The first step through the seventh step (s1-s7) are identical to the exemplary process 8000 described above and illustrated in FIG. 10A. Following the seventh step in the exemplary process 9000 of FIG. 11, a tenth step (s10) is performed. At the tenth step (s10) the transaction service provider processor 112 generates a subset of users based on the predictive model and the transactions analyzed for each user. The subset of users generated by the transaction service provider processor 112 includes a list of users who are considered to have the highest propensity to use their portable financial device to initiate transactions more frequently. The subset of users is transmitted from the transaction service provider processor 112 to the issuing institution processor 118.

With continued reference to FIG. 11, at an eleventh step (s11a-s11d), the issuing institution processor 118 automatically initiates a conversion action relating to the subset of users generated in the tenth step (s10). As previously described, a conversion action may include any action directed to incentivizing, educating, or encouraging a user 100 in the subset to more frequently use their portable financial device. The conversion action may be performed by the issuing institution processor 118 and/or the conversion action processor 117 by automatically enrolling users in the subset of users in at least one incentive program (s11a). The conversion action may be performed by the issuing institution processor 118 and/or the conversion action processor 117 to automatically transmit the subset of users to the issuing institution 104 (s11b) for further action directed to incentivize, educate, or encourage a user 100 in the subset to more frequently use their portable financial device. The conversion action may be performed by the issuing institution processor 118 and/or the conversion action processor 117 by automatically transmitting the subset of users to the merchant 106 (s11c) for further action directed to incentivize, educate, or encourage a user 100 in the subset to more frequently use their portable financial device. The conversion action may be performed by the issuing institution processor 118 and/or the conversion action processor by automatically transmitting a communication to the users in the subset of users (s11d).

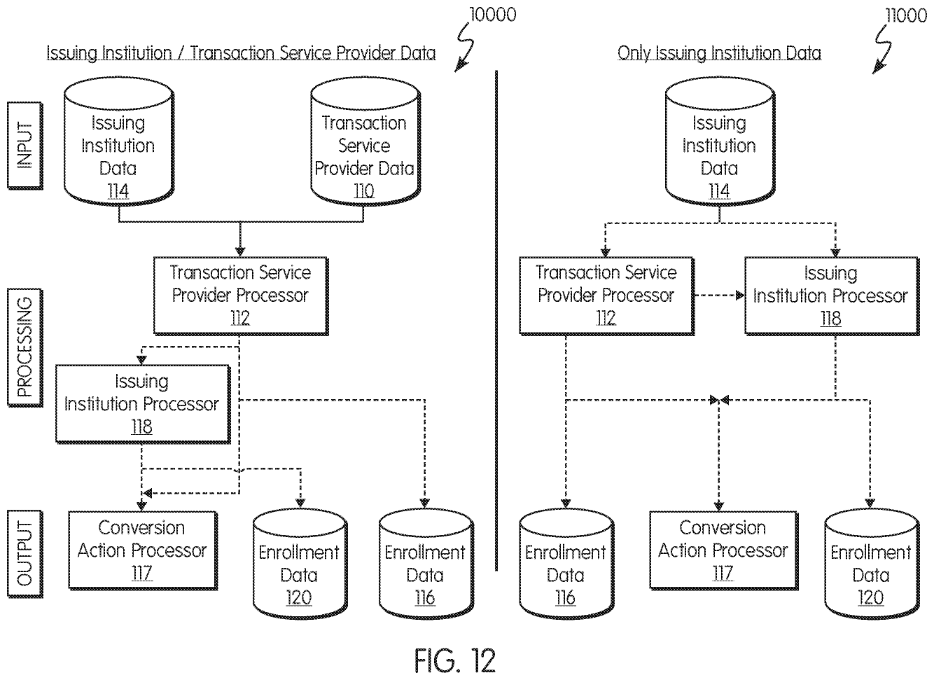

Referring to FIG. 12, a process flow diagram shows several processes for segmenting users based on transaction activity and propensity for conducting portable financial device transactions according to principles of the present invention. Process 10000 shows a process for segmenting users based on transaction activity and propensity for conducting portable financial device transactions according to principles of the present invention using data from the issuing institution 104 and the transaction service provider 102. In this process 10000, the transaction service provider processor 112 retrieves data from both the issuing institution database 114 and the transaction service provider database 110. The transaction service provider processor 112 processes the data based on any of the above-described methods to generate a subset of users having a higher propensity to use their portable financial device to initiate transactions more frequently. In some non-limiting embodiments, the transaction service provider processor 112 may transmit the subset to the conversion action processor 117 to initiate a conversion action. In some non-limiting embodiments, the transaction service provider processor 112 may automatically enroll the subset of users in an incentive program by transmitting the subset to an enrollment database 116. In some non-limiting embodiments, the transaction service provider processor 112 may transmit the subset of users to the issuing institution processor 118 for further action. In some non-limiting embodiments, the issuing institution processor 118 may automatically enroll the subset of users in an incentive program by transmitting the subset to an enrollment database 120. In some non-limiting embodiments, the issuing institution processor 118 may transmit the subset to the conversion action processor 117 to initiate a conversion action.

With continued reference to FIG. 12, process 11000 shows a process for segmenting users based on transaction activity and propensity for conducting portable financial device transactions according to principles of the present invention using data from the issuing institution 104 only. In this process 11000, the transaction service provider processor 112 or the issuing institution processor 118 retrieves data from the issuing institution database 114. The transaction service provider processor 112 or the issuing institution processor 118 processes the data based on any of the above-described methods to generate a subset of users having a higher propensity to use their portable financial device to initiate transactions more frequently. In some non-limiting embodiments, the transaction service provider processor 112 may transmit the subset to the conversion action processor 117 to initiate a conversion action. In some non-limiting embodiments, the transaction service provider processor 112 may automatically enroll the subset of users in an incentive program by transmitting the subset to an enrollment database 116. In some non-limiting embodiments, the issuing institution processor 118 may automatically enroll the subset of users in an incentive program by transmitting the subset to an enrollment database 120. In some non-limiting embodiments, the issuing institution processor 118 may transmit the subset to the conversion action processor 117 to initiate a conversion action.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment may be combined with one or more features of any other embodiment.

1.-7. (canceled)

8. A method of segmenting users based on transaction activity and propensity for conducting portable financial device transactions, comprising:
determining at least one subset of transaction data categories from a plurality of transaction data categories;
ranking the at least one subset of transaction data categories into at least one order;
generating, with at least one processor, at least one predictive model for determining user propensity for prospectively increasing a frequency of portable financial device transactions based at least partially on the ranking of the at least one subset of transaction data categories;
analyzing, with at least one processor, transaction data for portable financial device transactions initiated by each user of a plurality of users to identify at least one transaction for each user that corresponds to at least one transaction data category of the at least one subset of transaction data categories;
generating, with at least one processor, at least one subset of users of the plurality of users based at least partially on the at least one predictive model and the at least one transaction identified for each of the plurality of users; and
automatically initiating, with at least one processor, a conversion action to convert at least one user in the at least one subset of users to more frequent performance of portable financial device transactions.

9. The method of claim 8, wherein the conversion action comprises enrolling each user in the at least one subset of users in at least one incentive program.

10. The method of claim 8, wherein the conversion action comprises generating and/or transmitting a communication to each user in the at least one subset of users.

11. The method of claim 10, wherein the communication comprises at least one of the following: a web-based communication, an email communication, a text message, a telephone call, a push notification, an instant message, or any combination thereof.

12. The method of claim 8, wherein ranking the at least one subset of transaction data categories into the at least one order comprises assigning a weight value to each transaction data category of the at least one subset of transaction data categories.

13. The method of claim 8, wherein the at least one subset of transaction data categories comprises a first subset of transaction data categories and a second subset of transaction data categories, wherein the at least one predictive model comprises a first predictive model for users with less than a predefined number of transactions and is generated based at least partially on the first subset of transaction data categories and a second predictive model for users with at least a predefined number of transactions generated based at least partially on the second subset of transaction data categories.

14. The method of claim 13, wherein the first subset of transaction data categories comprises at least two of: amount of user cash withdrawals, average user international ticket size, user growth momentum of ticket size, days since last user transaction, user withdrawal consistency, and user card type.

15. The method of claim 13, wherein the second subset of transaction data categories comprises at least two of: number of user transactions, number of domestic user transactions, user growth momentum of monthly spending, days since last user transaction, number of market categories in which user is active, number of user supermarket transactions, amount of user spending at restaurants, and amount of user spending at gas stations.

16. The method of claim 8, wherein the portable financial device transactions comprise a plurality of transactions initiated with a primary account number.

17. The method of claim 8, wherein the at least one subset of users comprises users having a high propensity for prospectively increasing a frequency of portable financial device transactions based at least partially on the at least one predictive model.

18.-20. (canceled)

21. A computer program product for segmenting users based on transaction activity and propensity for conducting portable financial device transactions, comprising at least one non-transitory computer-readable medium including program instructions that, when executed by at least one processor cause the at least one processor to:
determine at least one subset of transaction data categories from a plurality of transaction data categories;
rank the at least one subset of transaction data categories into at least one order;
generate at least one predictive model for determining user propensity for prospectively increasing a frequency of portable financial device transactions based at least partially on the ranking of the at least one subset of transaction data categories;
analyze transaction data for portable financial device transactions initiated by each user of a plurality of users to identify at least one transaction for each user that corresponds to at least one transaction data category of the at least one subset of transaction data categories;
generate at least one subset of users of the plurality of users based at least partially on the at least one predictive model and the at least one transaction identified for each of the plurality of users; and
automatically initiate a conversion action to convert at least one user in the at least one subset of users to more frequent performance of portable financial device transactions.

22. The computer program product of claim 21, comprising a first computer-readable medium and a second computer-readable medium, wherein the first computer-readable medium is maintained and or hosted by a transaction service provider and the second computer-readable medium is located remote from the transaction service provider.

23. The computer program product of claim 22, wherein the conversion action comprises enrolling each user in the at least one subset of users in at least one incentive program or generating and/or transmitting a communication to each user in the at least one subset of users.

24. The computer program product of claim 23, wherein the communication comprises at least one of the following: a web-based communication, an email communication, a text message, a telephone call, a push notification, an instant message, or any combination thereof.

25. The computer program product of claim 21, wherein ranking the at least one subset of transaction data categories into the least one order comprises assigning a weight value to each transaction data category of the at least one subset of transaction data categories.

26. The computer program product of claim 21, wherein the at least one subset of transaction data categories comprises a first subset of transaction data categories and a second subset of transaction data categories, wherein the at least one predictive model comprises a first predictive model for users with less than a predefined number of transactions and is generated based at least partially on the first subset of transaction data categories and a second predictive model for users with at least a predefined number of transactions generated based at least partially on the second subset of transaction data categories.

27. The computer program product of claim 26, wherein the first subset of transaction data categories comprises at least two of: amount of user cash withdrawals, average user international ticket size, user growth momentum of ticket size, days since last user transaction, user withdrawal consistency, and user card type.

28. The computer program product of claim 26, wherein the second subset of transaction data categories comprises at least two of: number of user transactions, number of domestic user transactions, user growth momentum of monthly spending, days since last user transaction, number of market categories in which user is active, number of user supermarket transactions, amount of user spending at restaurants, and amount of user spending at gas stations.

29. The computer program product of claim 21, wherein the portable financial device transactions comprise a plurality of transactions initiated with a primary account number.

30. (canceled)

31. A system for segmenting users based on transaction activity and propensity for conducting portable financial device transactions, comprising:
at least one database comprising user transaction data, the user transaction data comprising: a plurality of transaction data categories and transaction data for portable financial device transactions initiated by each user of a plurality of users; and
at least one processor in communication with the at least one database, the at least one processor programmed or configured to:
determine at least one subset of transaction data categories from the plurality of transaction data categories;
rank the at least one subset of transaction data categories into at least one order;
generate at least one predictive model for determining user propensity for prospectively increasing a frequency of portable financial device transactions based at least partially on the ranking of the at least one subset of transaction data categories;
analyze the transaction data for portable financial device transactions initiated by each user of a plurality of users to identify at least one transaction for each user that corresponds to at least one transaction data category of the at least one subset of transaction data categories;
generate at least one subset of users of the plurality of users based at least partially on the at least one predictive model and the at least one transaction identified for each of the plurality of users; and
automatically initiate a conversion action to convert at least one user in the at least one subset of users to more frequent performance of portable financial device transactions.

32.-41. (canceled)
